(19) United States
(12) Patent Application Publication
(10) Pub. No.: US 2012/0164281 A1
(43) Pub. Date: Jun. 28, 2012

(54) Packaged fresh diced garlic and process for making same

(75) Inventor: William Joseph Lane, Bakersfield, CA (US)

(73) Assignee: The Garlic Co.

(21) Appl. No.: 13/385,552

(22) Filed: Feb. 23, 2012

Related U.S. Application Data
(63) Continuation-in-part of application No. 12/903,112, filed on Oct. 12, 2010.
(60) Provisional application No. 61/335,032, filed on Dec. 29, 2009.

(51) Int. Cl. A23L 1/223; A23L 1/015

(52) U.S. Cl. 426/106; 426/455; 426/395; 426/335; 426/638

(57) ABSTRACT

Ready-to-use, fresh diced garlic that has been washed and sanitized and disposed in a container from which gas can escape.

This application is a continuation-in-part of co-pending application Ser. No. 12/903,112, filed Dec. 27, 2010, which claims the earlier filing date of Provisional Patent Application No. 61/335,032, filed Dec. 29, 2009.

The present invention relates to packaged garlic, in particular, to packaged fresh diced garlic and methods for making same.

### BACKGROUND

Prior to the present invention, fresh (as opposed to dried or frozen) diced garlic for sale through normal distribution channels has been available only in a container of a preservative medium to prevent the growth of bacteria in the sugars and proteins that are released in the process of dicing the garlic and which would otherwise cause the garlic to deteriorate, turn a dark color and quickly (within days) become unsuitable for use. Garlic so packaged suffers from the disadvantages of high cost due to the presence of a preservative medium and of having to be separated from the preservative medium before.

### DEFINITIONS

As used herein, the term “process-ready cloves” refers to washed and skinned fresh cloves of garlic.

As used herein, the term “garlic pieces” or “pieces” refers to the form of garlic that results from cutting process-ready cloves into smaller pieces.

As used herein, “barrier material” refers to plastic packaging materials.

As used herein, “unidirectional barrier material” refers to barrier packaging material that allow garlic outgas to pass through in one direction and prevents air from passing through in the other direction.

As used herein, “non-breathable” barrier material refers to barrier material through which neither air nor garlic outgas can pass in either direction.

As used herein, “vacuum sealed” means two barrier members sealed to each other and air (or other gases) removed from any space between them.

As used herein, “preservative medium” refers to a fluid or gel such as olive or grape seed oil or vinegar or the like in which fresh garlic pieces are immersed.

### BRIEF DESCRIPTION OF THE INVENTION

The present invention provides shelf-stable, packaged fresh diced garlic that does not require a preservative medium, thus permitting immediate out-of-the-package use.

In one embodiment, the process of the present invention comprises the steps of: (1) processing harvested garlic bulbs into process-ready garlic cloves; (2) dicing the cloves into garlic pieces; (3) washing and sanitizing the garlic pieces to remove the soluble fraction of sugar/proteins released by dicing as well as bacteria that might be present; (4) drying (removing excess moisture from) the washed garlic pieces; and (5) packaging the processed garlic pieces in a container from which out gas from the garlic pieces can escape. In another embodiment of the invention, the steps following the removal of excess moisture comprise: (5a) vacuum sealing the washed and dried garlic pieces in a pouch receptacle having unidirectional barrier material that permits outgas from garlic pieces within the receptacle to escape, but does not allow air to enter.

These and other aspects and features of the present invention will be better understood from the following detailed description of the preferred embodiments when read in conjunction with the appended drawings.

### DESCRIPTION OF THE DRAWINGS

FIG. 1 is a process flow chart illustrating the process of the invention that produces the package of ready-to-use, fresh diced garlic of the invention;

FIG. 2 is an exploded perspective view of components of a pouch of the present invention which includes a unidirectional barrier member; and

FIG. 3 is a process flow chart illustrating a second preferred embodiment of the process of the invention that produces a container of ready-to-use, fresh diced garlic of the invention.

### DETAILED DESCRIPTION OF THE INVENTION

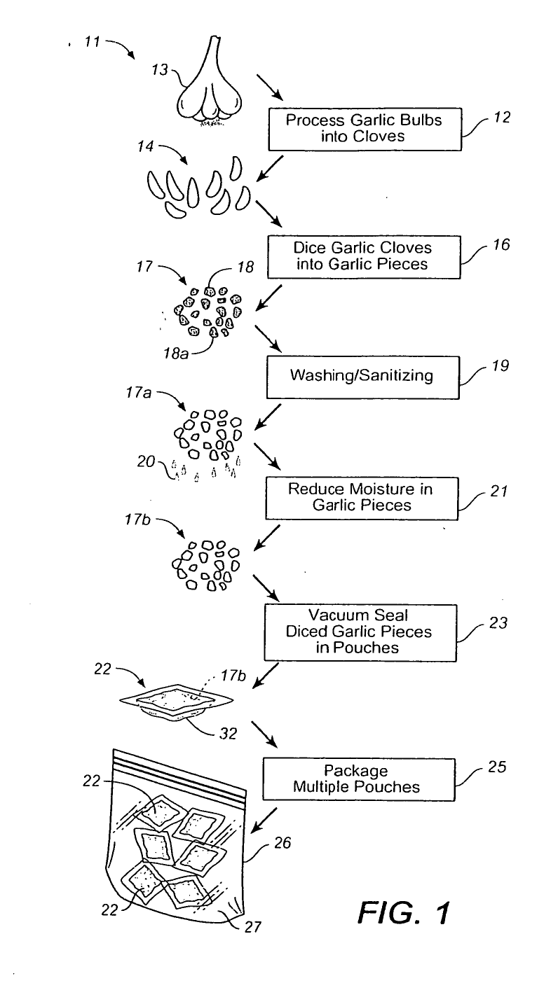

Referring to FIG. 1, the process 11 of the present invention comprises a series of steps that result in packaged, ready-to-use, fresh diced garlic 22 that is not immersed in a preserved medium and thus does not require additional preparation prior to use. The fresh diced garlic so processed and packaged is shelf-stable (capable of maintaining its freshness under normal refrigeration) for a period of months, which is sufficient to deliver the product to retail outlets and for it to have an ample refrigerated shelf life after purchase.

The initial step 12 processes garlic bulbs 13 into peeled and washed (process-ready) garlic cloves 14, all in a manner well known in the industry. Once step 12 has been completed, the process-ready garlic cloves 14 are put through dicing step 16, producing garlic pieces 17 which can be of generally uniform-size pieces or random-size pieces, depending on their intended use. Dicing step 16 by which garlic cloves 14 are cut into garlic pieces 17 (uniform or random) is a process well known in the industry that can be accomplished by a number of different commercially available appliances as well as manually.

Dicing cloves 14 into smaller pieces 17 unavoidably releases sugars and proteins 18 from cloves 14, which creates a breeding medium for bacteria 18a that can cause the garlic pieces 17 to create outgas, quickly deteriorate, turn a darker color and become unusable.

As soon as possible and, in a preferred embodiment of the invention, no more than one hour after the dicing step 16 has been completed, the diced garlic pieces 17 are put through a washing/sanitizing step 19. The washing component of washing/sanitizing step 19 removes the soluble fraction of the released sugars and proteins 18. The sanitizing component of step 19 kills bacteria 18a on the diced pieces 17. The result of step 19 is washed garlic pieces 17a.

While the washing/sanitizing step 19 advantageously combines the washing and sanitizing components and performs them simultaneously, it is within the scope of the invention for these components to be performed separately (serially), as will be obvious to those skilled in the art. It may also be possible to eliminate the sanitizing component of step 19 where bacteria are not at a level of concern.

There are a number of chemical solutions that are suitable for the washing/sanitizing step 19. In one embodiment of the invention, the washing component of step 19 includes removing the soluble fraction of the released sugars and proteins 18 by rinsing the garlic pieces 17 with a solution of chlorine in water at a concentration of between 80 and 120 ppm (parts per million) and preferably approximately 100 ppm. The sanitization component of washing step 19 comprises rinsing the pieces 17 in parasitic acid in water at a concentration of between 60 and 100 ppm and preferably approximately 80 ppm. There are several ways to apply the washing and sanitizing components of step 19 which can accomplish the desired result. In one embodiment, the garlic pieces are disposed in a washing/sanitizing solution. In another embodiment, the solutions are sprayed onto the garlic pieces 17. Again, the washing and sanitizing components of step 19 can be performed separately.

The result of step 19 is washed and sanitized garlic pieces 17a that have excess moisture 20. To remove the excess moisture 20, garlic pieces 17a are put through a moisture-reducing (drying) step 21 to reduce the excess moisture 20 in a manner that does not “cook” the garlic and produces package-ready garlic pieces 17b. In a preferred embodiment, the moisture-reducing step 21 takes place within one hour of the dicing step 16. While there are several known methods for drying garlic, in the present invention, it is important not to use heat to do the drying, as this will tend to “cook” the garlic. In a preferred embodiment of the invention, the moisture-reducing step 21 is accomplished using a spin dryer of the type, for example, used in the lettuce industry. Centrifugal force and not heat drives the excess moisture 20 from the garlic pieces 17a to produce package-ready garlic pieces 17b from which the soluble fraction of sugars and proteins 18 has been removed, bacteria 18a has been reduced (where required) and excess moisture 20 driven off.

The package-ready garlic pieces 17b are, as soon as possible after moisture reducing step 21 and preferably within one hour thereof, put through barrier packaging step 23 in which the garlic pieces 17b are vacuum-sealed in pouches 22 without the inclusion of a preservative medium. Pouches 22 are made from a combination of plastic barrier materials of specific characteristics.

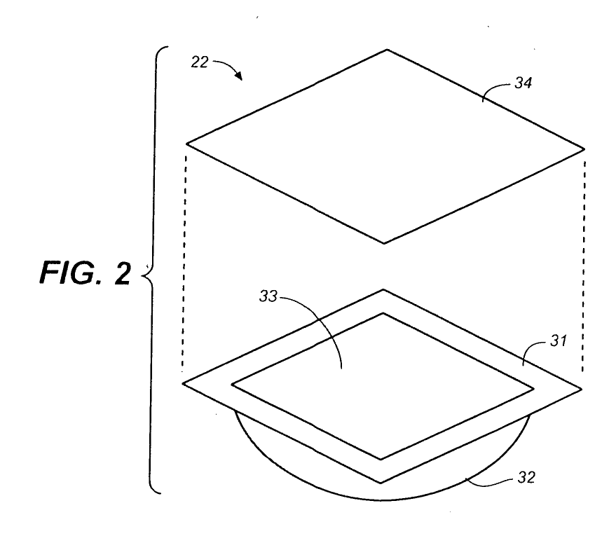

Referring also to FIG. 2, a pouch 22 includes a pouch receptacle member 31 made from a plastic barrier material that does not permit gas (including air) to pass through it and that can be heat stressed and molded to form a receptacle 32 defining an interior space 33 for receiving and containing washed and dried garlic pieces 17b. The receptacle member 31 of pouch 22 can be formed from one of several suitable commercially available plastic barrier materials such as that available from Advanced Films LLC of Vancouver, Wash., under product number AFS-2311.

Because the processed garlic pieces 17b will, in time, outgas in the vacuum sealed pouches 22, it is necessary for this outgas to escape and not build up around the garlic pieces 17b, which will cause them to deteriorate. At the same time, it is important to maintain the vacuum within pouch 22 by preventing air (oxygen) from entering the pouch interior space 32 and causing degradation of the garlic pieces 17b.

To accomplish these competing demands, a receptacle-sealing member 34 of a laminated plastic unidirectional barrier material is vacuum-sealed to the pouch receptacle member 31 over interior space 33, enclosing that space. Garlic pieces 17b enclosed within interior space 33 (see FIG. 1) become vacuum encapsulated when member 34 is vacuum-sealed to member 31. The process of vacuum sealing receptacle 32 in a manner well known in the industry withdraws the air and gas in receptacle 32, causing the receptacle to deform and closely surround the contained garlic pieces 17b as indicated in FIG. 1.

Member 34 (made from commercially available multilayer unidirectional plastic packaging barrier material) permits garlic outgas to pass out of interior space 33 through barrier member 34. This same receptacle-sealing member 34 prevents air (oxygen) from entering space 33 through material 34 and breaking the vacuum. A barrier material capable of performing as described in connection with receptacle-sealing member 34 is commercially available from a number of sources such as Advanced Films, LLC of Vancouver, Wash., under product number AFS-4311. The garlic pieces 17b vacuum-sealed in receptacle 32 will remain fresh for months under normal refrigeration.

In one embodiment of the invention, pouches 22 are sized to each contain a measured amount of garlic pieces 17b (e.g., one-half ounce) and a plurality of pouches 22 are packaged together by packaging step 25 into a sealed commercial package 26.

In order to prevent the outgases from the garlic pieces 17b in pouches 22 from building up in commercial package 26, package 26 is preferably made of a barrier material 27 that allows gas to pass through the material 27 in both directions. Such packaging materials are in common use and are well known to those skilled in the art. Since the commercial package 26 is not vacuum-sealed, it is not necessary to prevent air from entering it.

Because the outgases from pouches 22 can escape into and through the package 26, the enclosed space where a package 26 is kept refrigerated can be infused with the odor of garlic from the outgas, which, to some, is not desirable. In a preferred embodiment, vacuum-sealing the diced, washed and dried garlic pieces 17b into pouches 22 promptly, and preferably within two hours or less of the time the garlic is diced, greatly reduces the amount of outgas and thus extends the shelf life and the likelihood of undesirable odors from a package 26.

Thus, the process of the present invention provides packaged, fresh diced garlic that is shelf-stable for months and immediately ready for use without any additional processing such as the need to separate it from a preservative medium.

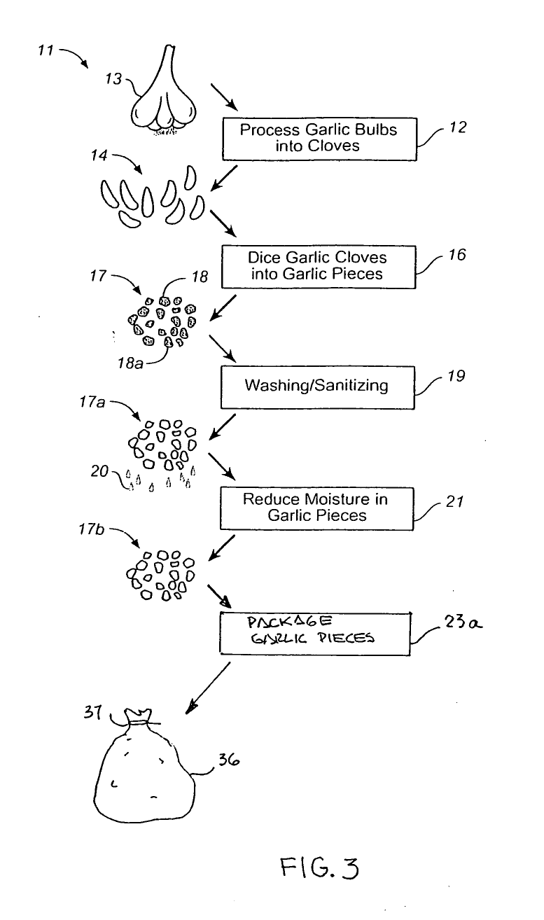

The embodiment described above is most appropriate for personal or family use where relatively small quantities of garlic pieces (measured in ounces) are used at a time and over the course of months. The unidirectional barrier material 34 assures that the refrigerated garlic pieces stay fresh and usable for 60 to 90 days or more during which the garlic are waiting to be consumed. In contrast, restaurants, food processors and institutional kitchens will typically consume pounds of diced garlic weekly, if not daily, whereby the garlic will spend far less time on the shelf and therefore requiring less shelf life. Accordingly, in one embodiment of the invention, a quantity of garlic pieces weighing 1 to 30 pounds that will be used by customers who typically consume such quantities in 30 days or less, are produced by an alternative process diagramed in FIG. 3. The process is the same as described above with reference to FIG. 1 up to and including step 21 which produces diced, washed/sanitized, and dried garlic pieces 17b. The garlic pieces 17b are then packaged (step 23a) in, for example, a plastic pouch container 36. It will occur to those skilled in the art that a plastic tub, glass container or other rigid container could be used as well. Since the process of washing/sanitizing and drying the garlic pieces alone, as described above, retards natural degradation of diced garlic for 30 to 45 days or more when refrigerated and packaged in traditional packaging materials or containers, a unidirectional sealing material such as member 34 (FIG. 2) is not required. Although the processing steps 19 and 21 greatly retard the amount of outgas from garlic pieces 17b in pouch container 36, some outgas will naturally occur, so to prevent undesirable pressure from building up within container 36, some means for the outgas to escape is provided. For example, in sheet plastic packaging, laser holes can be provided (not shown) that provide the escape route; in glass jars, the tops are used without gaskets; in plastic pouches, as shown, the neck closure 37 is not airtight, etc. By reducing sugars and proteins and bacteria from diced garlic pieces to retard degradation and reduce outgassing before being placed in a container that allows outgas to escape, the present invention provides a container of fresh garlic pieces 17b which will remain fresh and ready for use for up to a month when properly refrigerated.

Of course, various changes, modifications and alterations in the teachings of the present invention may be contemplated by those skilled in the art without departing from the intended spirit and scope thereof. As such, it is intended that the present invention only be limited by the terms of the appended claims.

What is claimed is:

1. A process for packaged fresh garlic pieces, comprising;
dicing process-ready fresh garlic cloves into garlic pieces whereby sugars and proteins are released from the process-ready fresh garlic cloves which produce outgas;
washing the garlic pieces to remove the soluble fraction of sugars and proteins whereby excess moisture is added to the garlic pieces; and
drying the washed garlic pieces to remove excess moisture from washing.

2. The process of claim 1 further comprising:
packaging the washed and dried garlic pieces in a container from which outgasses from the garlic pieces can escape without a preservative medium.

3. The process of claim lwhere the drying step is performed without added heat.

4. The process of claim lwhere the drying step is performed by spinning the garlic pieces.

5. The process of claim 1 further comprising washing the garlic pieces to reduce bacteria on the garlic pieces.

6. The process of claim 1 wherein the washing step to remove soluble sugars and proteins comprises washing the garlic pieces in a solution of chlorine.

7. The process of claim 6 where the chlorine solution comprises a solution of chlorine in water at a concentration of between 80 and 120 Ppm.

8. The process of claim 2 wherein the washing step to remove soluble sugars and proteins comprises washing the garlic pieces in a solution of chlorine.

9. The process of claim 5 wherein the washing step to reduce bacteria comprises washing the garlic pieces in a solution of parasitic acid.

10. The process of claim 9 where the solution of parasitic acid comprises parasitic acid in water at a concentration of between 60 and 100 ppm

11. The process of claim 1 wherein:
said washing step takes place within one hour after said dicing step.

12. The process of claim 1 wherein:
said drying step takes place within one hours after said washing step.

13. The process of claim 2 wherein said packaging step takes place within one hour after said drying step.

14. The process of claim 2 wherein the quantity of garlic pieces packaged in the container is one pound or more.

15. Packaged garlic comprising:
a container;
diced fresh garlic pieces that have been washed to remove soluble fractions of sugars and proteins released when the garlic is diced disposed in said container without a preservative medium wherein said garlic pieces produce some outgas in said container.

16. The packaged garlic of claim 15 where the amount of said diced garlic is one pound or more and said container includes openings through which outgasses can escape.

17. The packaged garlic of claim 16 wherein said diced fresh garlic has been washed to remove bacterial growth and dried before being disposed in said container.

18. The packaged garlic of claim 17 where the amount of said diced garlic pieces is one pound or more and said container permits outgas to escape.
